(19) United States
(12) Patent Application Publication
(10) Pub. No.: US 2010/0320344 A1
(43) Pub. Date: Dec. 23, 2010

(54) Clip for Vessel

(75) Inventor: Deok-Whan Choi, Seoul (KR)

Correspondence Address: WOMBLE CARLYLE SANDRIDGE & RICE, PLLC, ATTN: PATENT DOCKETING, P.O. BOX 7037, ATLANTA, GA, 30357-0037, US

(73) Assignee: Plus & Divide Co., Ltd., Seoul (KR)

(21) Appl. No.: 12/781,569

(22) Filed: May 17, 2010

Related U.S. Application Data
(63) Continuation-in-part of application No. PCT/KR2008/006635, filed on Nov. 11, 2008.

(30) Foreign Application Priority Data
Nov. 16, 2007 (KR) 10-2007-0117240
May 13, 2008 (KR) 10-2008-0044048

(51) Int. Cl. F16B 2/20; F16M 13/02

(52) U.S. Cl. 248/229.26; 24/457

(57) ABSTRACT

A vessel clip can stack a plurality of boxes on a usual vessel by providing a shelf function, where a content in each box is visible so as to improve decoration effect, and a candle can be stuck through a candle sticking member without sticking the candle in food directly. Accordingly, the vessel clip can provide effect such as a cake through the shape of the vessel formed by stacking the boxes and display effect due to the candle decoration. Thus, a candle event can be performed using various foods instead of conventional cakes with the same effect.

### RELATED APPLICATIONS

This is a Continuation-in-part of International Patent Application No. PCT/KR2008/006635, filed, 11 Nov. 2008, which published in English as WO 2009/064101, and claims priority to KR 10-2007-0117240, filed 16 Nov. 2007 and also to KR 10-2008-0044048, filed 13 May 2008. The contents of the aforementioned International and Priority Applications are incorporated by reference in their entirety.

### TECHNICAL FIELD

The present invention relates to a vessel clip, and more particularly, to a vessel clip that can stack a plurality of boxes on a usual vessel by providing a shelf function, where a content in each box is visible so as to improve decoration effect, and a candle can be stuck through a candle sticking member without sticking the candle in food directly. Accordingly, the vessel clip can provide effect such as a cake through the shape of the vessel formed by stacking the boxes and display effect due to the candle decoration. Thus, according to the vessel clip of the present invention, a candle event can be performed using various foods instead of conventional cakes with the same effect.

### BACKGROUND ART

Generally, a ‘candle event’ is almost always performed in a birthday or other events, where candles are stuck in a particular food and a light is put to each candle.

Cakes have been conventionally used as the food to be stuck with the candle in the candle event. Also recently, the cake is indispensably used in the candle event.

That is the reason that flames of the candles look better when the candles are stuck and fired because the candles have a shape of tower having a predetermined height.

However, in the case where the cakes are used regardless of meaning of the event or taste, the cakes have been frequently discarded, thereby causing economic loss and environment pollution by the food garbage.

Particularly, in the birthday event in which much food other than the cake are prepared, the economic and environmental problems become larger because the cake is prepared only for the candle event regardless of amount of the other prepared foods.

Recently, a small pie or a stack of breads provided with a candle has been used instead of the cake. However, appearance and display effect have been not good compared than the cake.

### SUMMARY

Accordingly, a first object of the present invention is to provide a vessel clip that can improve appearance of a vessel and stick a candle on the vessel by using a clip. Thus, the vessel clip can produce a main event effect such as a candle event using a cake. A user can perform the event in a state that food suitable to meaning of the event or taste is contained in the vessel regardless of preparing a particular food such as a cake obligatorily. In other words, options for food become wider.

The second object of the present invention is to provide a vessel clip that can reduce cost of an event by not buying food for the candle event unnecessarily because of wide options for food.

The third object of the present invention is to provide a vessel clip that can reduce food garbage by using food matched to a user's taste in the event.

The fourth object of the present invention is to provide a vessel clip that can improve economic effect by reusing the vessel clip for the candle event later.

The fifth object of the present invention is to provide a vessel clip that can selectively or simultaneously provide the candle event function and food display effect.

According to an aspect of the present invention, there is provided a vessel clip used for a vessel whose upper part is open, which includes: a clip body fastened to a side wall of the vessel body; a mounting part, extended from the clip body, located in a receiving space of the vessel body; and a light-emitting member installing part extended from the clip body in order to install a light-emitting member thereon.

A plurality of vessels may be stacked on the vessel clip by seating other vessels on the mounting part due to the structure, thereby improving food containing efficiency and display effect.

A candle event may be performed by installing the light-emitting member such as a candle on the vessel through the light-emitting member installing part.

As described above, the vessel clip according to the present invention can stack a plurality of vessel bodies through the mounting part and light-emitting member installing part and simultaneously install the light-emitting member such as the candle on the vessel body. Thus, the vessel clip produces following effects.

First, the vessel clip can provide display effect such as a cake in itself due to the shape of multi-layered stack and light-emitting member when food is contained in each vessel body. Accordingly, the food contained in the vessel body can be used as food for a main event instead of a special food such as the cake.

Second, cost for food can be reduced because food matched to the user's taste is selectively used as main food and special food such as the cake is unnecessary.

Third, waste of untasty food used only for the event can be reduced because food matched to the user's taste can be selected as the main food.

Fourth, the vessel clip can be directly installed on vessels such as pizza or chicken boxes, thereby providing display effect. Thus, additional vessels are unnecessary.

Fifth, the vessel clip can be reused because it is detachable from the vessel body.

Sixth, in a viewpoint of managing business such as pizza or chicken food, the effect such as a cake can be obtained by using only pizza or chicken, thereby improving a sale scale.

### BRIEF DESCRIPTION OF DRAWINGS

FIG. 1 is an exploded perspective view illustrating a structure in which a clip and a vessel body are combined with each other;

FIG. 2 is a sectional view illustrating a state that the clip is combined with the vessel body;

FIG. 3 is a partial sectional view illustrating a state that the clip is provided with a lower support part;

FIG. 4 is a view illustrating a state that a shape of a fixing member of a light-emitting member installing part of the clip is changed;

FIG. 5 is a view illustrating a structure that elastic force is applied to inner support part and outer support part;

FIG. 6 is a view illustrating a state that an auxiliary coupling groove is further formed in a coupling groove between the inner support part and outer support part;

FIG. 7 is a view illustrating a state that the clip is combined with the vessel body through an additional attaching member;

FIG. 8 is a view illustrating a state that a pin type attaching member is used;

FIG. 9 is a view illustrating a state that a hook part is formed in a pin type on a mounting part;

FIG. 10 is a view illustrating a state that the hook part is formed in an attaching member type on the mounting part;

FIG. 11 is a view illustrating a structure modification example of the clip when the vessel body is circular;

FIG. 12 is a view illustrating a stack structure of second and third vessel bodies when the vessel body is circular;

FIG. 13 is a view illustrating a state that modified clips are provided at corners of the vessel body;

FIGS. 14 and 15 are views illustrating states that the light-emitting members are provided to the clips combined with the vessel body;

FIG. 16 is an exploded perspective view illustrating process to stack the vessel bodies in a multi-layered structure;

FIG. 17 is a plan view illustrating a state that the vessel bodies have been stacked;

FIGS. 18 and 19 are views respectively illustrating states that the vessel bodies have been stacked in the multi-layered structure;

FIG. 20 is a view illustrating a state that the second vessel body is provided on the first vessel body by forming the mounting part of the clip at an upper end of the inner support part;

FIG. 21 is a view illustrating a state that the vessel bodies stacked in the multi-layered structure is received in a separate outer case;

FIG. 22 is a view illustrating a case where a bar type light-emitting member stand is arranged in the receiving space of the vessel body;

FIG. 23 is a view illustrating a state that the light-emitting member stand is provided to be detachable from the clip body;

FIG. 24 is a view illustrating a state that an auxiliary light-emitting member stand is further provided to the light-emitting member installing part;

FIG. 25 is a view illustrating a state that a melted candle blocking plate is seated on the light-emitting member stand;

FIG. 26 is a view illustrating a state that the melted candle blocking plate and fixing members of the each light-emitting member stand are combined with each other through through-holes formed in the melted candle blocking plate;

FIG. 27 is a view illustrating a state that the melted candle blocking plate is inserted into a cut portion of the light-emitting member stand;

FIG. 28 is a view illustrating a state that the bar type light-emitting member stand is provided to the uppermost vessel body of the vessel bodies that have been stacked;

FIGS. 29 and 30 are views respectively illustrating states that the light-emitting member stand is provided to be extended/retracted in multi-stages; and

FIG. 31 is a view illustrating a state that the mounting part and hook part are formed at a tip of the bar type light-emitting member stand over the vessel body.

FIG. 32 is a view illustrating a stand for a candle blocking plate.

### DETAILED DESCRIPTION

A vessel clip according to the present invention is basically used for a vessel whose upper part is open and includes a clip body fastened to a side wall of the vessel body, a mounting part that is extended from the clip body and located in a receiving space of the vessel body, and a light-emitting member installing part extended from the clip body in order to install a light-emitting member thereon.

A plurality of vessels may be stacked on the vessel clip by seating other vessels on the mounting part due to the structure, thereby improving food containing efficiency and display effect.

A candle event may be performed by installing the light-emitting member such as a candle on the vessel through the light-emitting member installing part.

Constructions and operations of various embodiments of the present invention will be explained in detail with reference to accompanying drawings below.

In the description below, goods contained in the vessel is assumed to be food, but not limited thereto.

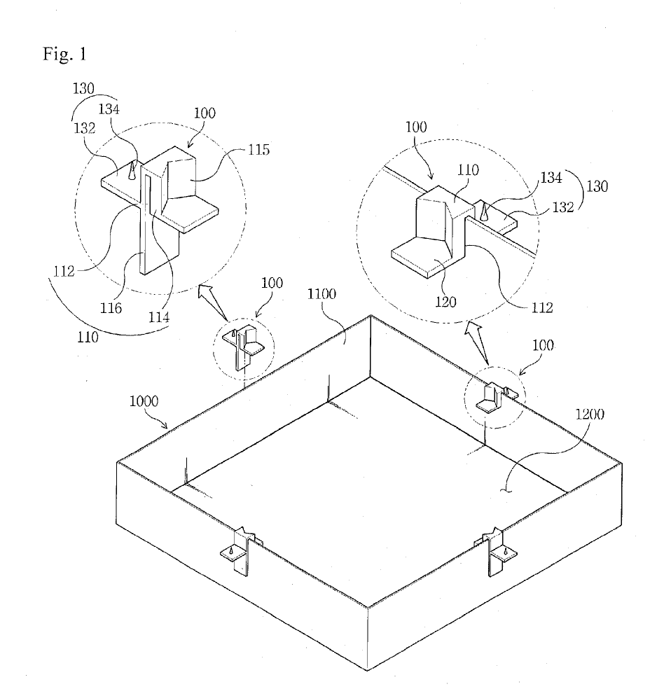

Referring to FIG. 1, a vessel clip 100 is basically used in a usual vessel whose upper part is open. The vessel clip 100 includes a clip body 110, a mounting part 120 and a light-emitting member installing part 130.

A vessel body 1000 receives the content such as food. Front, rear and bottom surface of the vessel body 1000 are blocked by a side wall 1100, thereby forming a receiving space 1200 inside. The upper part of the vessel body 1000 is open.

The vessel body 1000 is shown in a rectangular shape. However, it may be circular, triangular or other shape as long as it is a vessel with a side wall.

In addition, the side wall of the vessel may be formed by folding a paper such as a pizza box, or may be formed in an integrated type such as a usual vessel. Material of the vessel is not limited as long as the vessel clip 100 can keep the shape of the side wall.

The vessel clip 100 applied in the usual vessel can stack a plurality of the vessel body 1000 and produce effect the same as a cake through installing a light-emitting member 4000 on the vessel body 1000. The vessel clip 100 includes the clip body 110, a mounting part 120 and a light-emitting member installing part 130.

The clip body 110 is vertically formed to have a predetermined length. A coupling groove 112 having a predetermined length is upward formed at a lower part of the clip body 110, where the side wall 1100 of the vessel body 1000 is inserted into the coupling groove 112. Both sides of the coupling groove 112 are open so as to insert the vessel body 1000 smoothly.

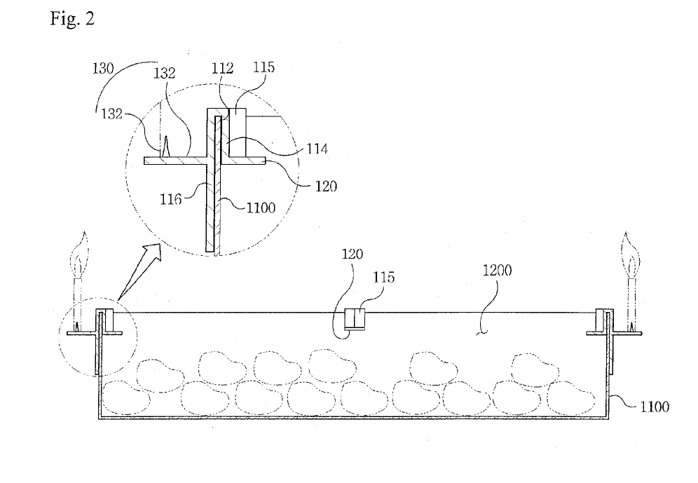

Inner and outer support parts 114 and 116 are provided at both sides of the coupling groove 112 as shown in FIG. 2, where the inner support part 114 is located on an inner surface of the side wall 1100 and the outer support part 116 is located on an outer surface of the vessel body 1000 when the coupling groove 112 is combined with the vessel body 1000.

Referring to FIG. 1, a hook part 115 is formed on a front surface of the inner support part 114 in order to restrict movement of a second vessel body 2000 when the second vessel body 2000 is seated on the mounting part 120 to be described later. The hook part 115 may be formed as a V-shaped groove having a vertically extending vertex as seen in a top view of the vessel clip mounted on the first vessel 1000c1. Accordingly, when the angular second vessel body 2000 is laid on the mounting part 120, each corner of the second vessel body 2000 is inserted into the groove, thereby preventing unnecessary movement of the second vessel body 2000.

Of course, when the hook part 115 is formed in a shape of a groove, the shape of groove and an angle of concave surface may be modified according to a shape of the corner of the second vessel body 2000.

The inner support part 114 is formed shorter than a height of the side wall 1100 of the vessel body 1000 so as to make the mounting part 120 to be spaced by a predetermined height from a bottom of the vessel body 1000. Accordingly, when the second vessel body 2000 is seated thereon, the receiving space 1200 is maximally secured between the bottoms of the first and second vessel bodies 1000 and 2000, thereby allowing the content to be smoothly received.

The mounting part 120 is provided at the front of the inner support part 114 of the clip body 110 having the above construction, thereby allowing the second vessel body 2000 to be stacked in a multi-layered structure.

The mounting part 120 is a plate type and projected from a lower end of the inner support part 114 perpendicularly to the inner support part 114.

Accordingly, the mounting part 120 is located inside the receiving space 1200 of the vessel body 1000. In this time, the light-emitting member installing part 130 is spaced by a predetermined height from the bottom of the receiving space 1200 due to the length of the inner support part 114.

On the other hand, the outer support part 116 contacted to the outer surface of the side wall 1100 is formed to have a height similar to the side wall, thereby increasing an area of the surface contacted to the side wall. Accordingly, when the vessel body is stacked, the vessel clip 100 is bent toward the receiving space 1200 by weight, thereby preventing the stacked vessel body from being separated from the vessel body 1000.

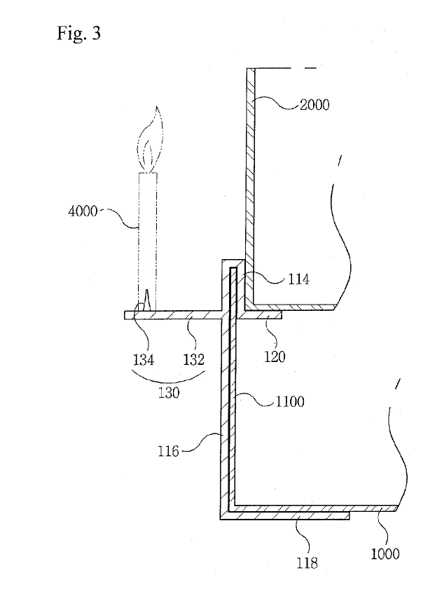

In addition, as shown in FIG. 3, for more stable coupling, the outer support part 116 may be formed taller than the height of the side wall 1100. A lower support part 118 to support the bottom of the vessel body 1000 may be further formed to extend at an angle from the outer support part 116 in the same general direction as the mounting part 120 and constitute a bent portion of the outer support part 116.

In this time, the lower support part 118 and outer support part 116 are contacted simultaneously to the side wall 1100 and bottom of the vessel body 1000, thereby improving the fastening strength.

A light-emitting member installing part 130 is provided on one surface of the outer support part 116. A light-emitting member 4000 such as a candle used in a candle event is installed/fixed on the light-emitting member installing part 130. The light-emitting member installing part 130 includes a light-emitting member stand 132 projected in a plate type such as the mounting part from the outer surface of the outer support part 116 and a fixing member 134 to fix the light-emitting member 4000 on the light-emitting member stand 132.

In this time, in a case where the light-emitting member 4000 is a candle as shown in the drawing, flame of the candle should be spaced by a proper gap from the second vessel body 2000 stacked on the vessel body 1000 by adjusting a projected length of the light-emitting member stand 132 in order to prevent a fire.

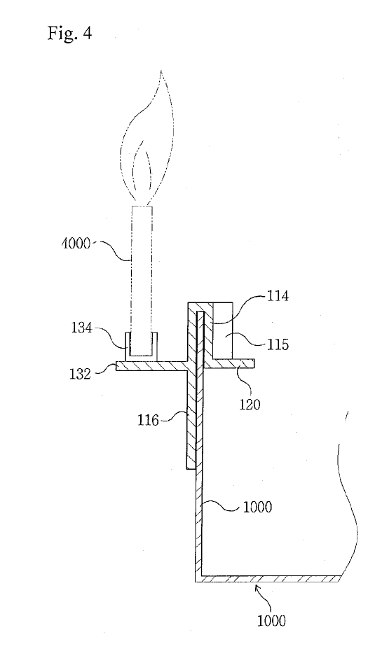

In addition, in a case where the light-emitting member 4000 is the candle, the fixing member 134 is formed to stick the candle merely as shown in FIGS. 3 and 4. However, in a case where the light-emitting member 4000 is a light bulb, a socket type fixing member is used.

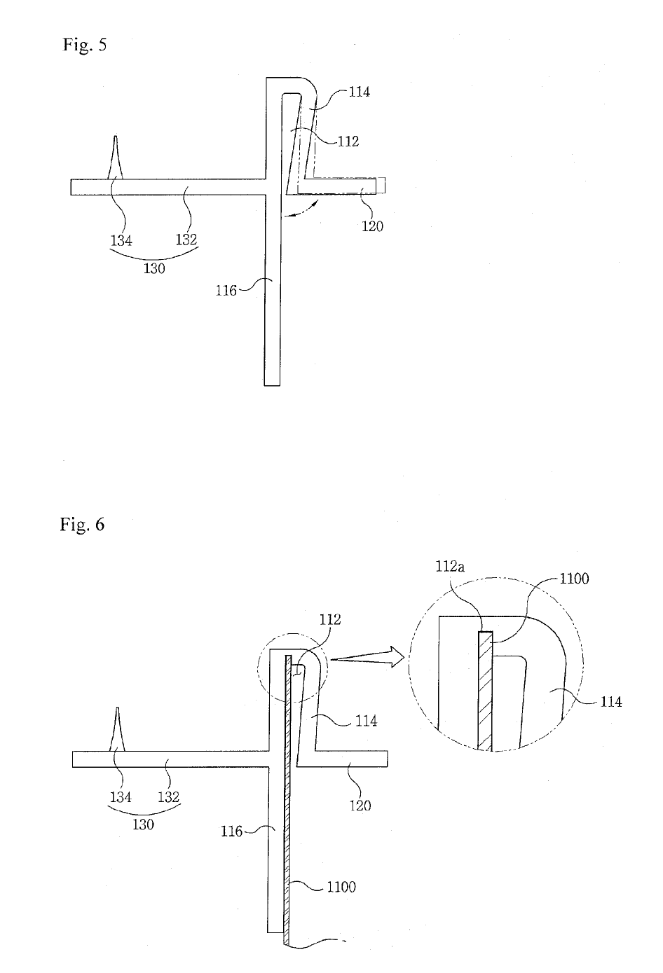

The structure of the vessel clip 100 may be variously modified. As shown in FIG. 5, elastic force may be applied to the inner and outer support part 114 and outer support part 116 in order to improve fastening strength by the elastic force when the vessel clip 100 is fastened to the side wall 1100.

In addition, the vessel clip 100 can be used in various fields because it can be fastened regardless of a thickness of the side wall.

In addition, as shown in FIG. 6, when an auxiliary coupling groove 112a in communication with, and thinner than, the coupling groove 112 is formed at a portion to connect the inner and outer support parts 114 and 116 to each other and is used to receive a side wall that is too thin to be grasped with elastic force alone, the vessel clip 100 is installed through receiving the side wall into the auxiliary coupling groove 112a.

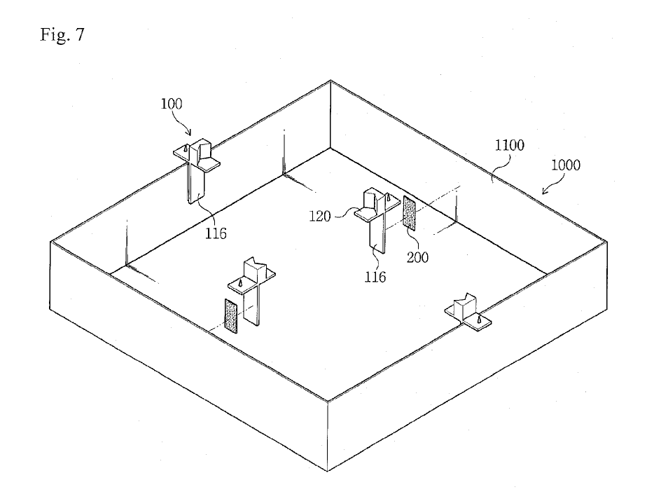

In addition, the vessel clip 100 and side wall 1100 may be combined with each other through a method other than the simple insertion type. In some embodiments, only one of the inner support part and the outer support part is integrally formed to have one-piece construction with the clip body. For example, as shown in FIG. 7, only the outer support part 116 is formed in a downwardly directed manner without forming the coupling groove in the clip with an inner support part. Then, an attaching member 200 is provided on a front or rear surface of the outer support part 116 and the vessel clip 100 is attached to the inner or outer surface of the side wall 1100 through the attaching member 200.

In this time, the attaching member 200 may be a usual double-coated tape, a bonding adhesive or an adsorption tape. If the side wall 1100 is metal, the vessel clip 100 can be easily attached by using a magnet as the attaching member 200.

Of course, a kind of the attaching member 200 may be changed according to material or surface condition of the side wall.

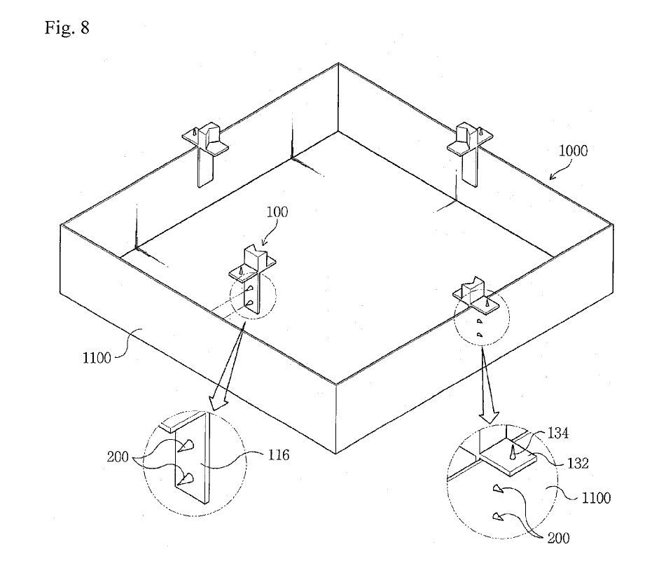

In addition, as shown in FIG. 8, a pin type attaching member 200 may be provided to pass through the side wall. In other words, a tack type vessel clip 100 may be used.

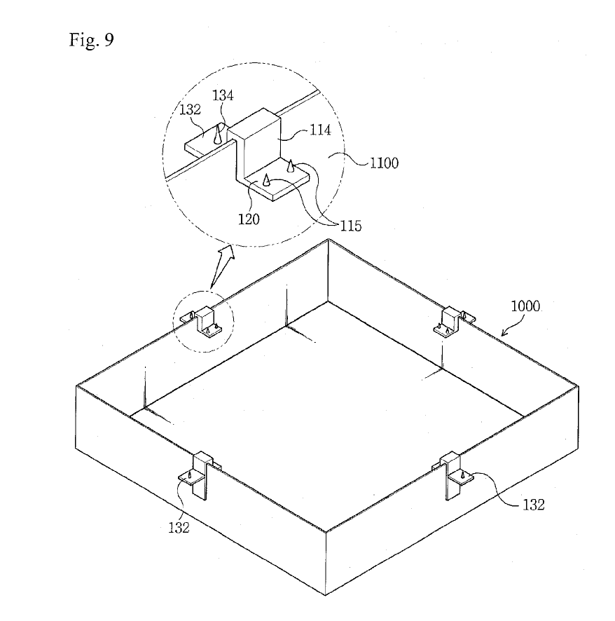

In addition, a shape of the hook part 115 formed in the groove type at the inner support part 114 may be changed into a pin type on the mounting part 120 as shown in FIG. 9. In this time, when the second vessel body 2000 is seated on the mounting part 120, the pin on the mounting part 120 passes through the bottom of the second vessel body 2000, thereby fixing the second vessel body 2000. Thus, fixing force is enhanced compared to the case where the hook part 115 is formed in the groove type. In such case, while the light-emitting member part is provided with at least one upstanding pin configured to fix a candle, the mounting part is also provided with at least one upstanding pin configured to fix the second vessel.

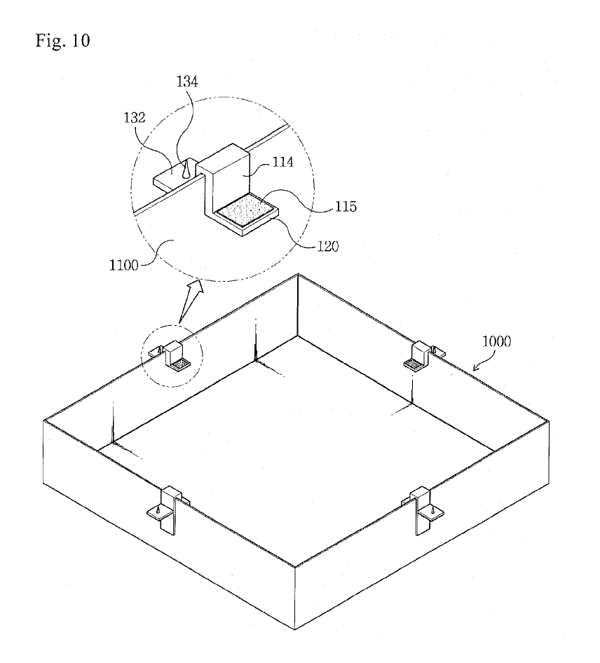

In addition, as shown in FIG. 10, the hook part 115 may be provided on the mounting part 120 in the form of an adsorption sheet, adhesive sheet or magnet.

When the hook part 115 is formed separately from the vessel clip 100, the hook part 115 can be easily formed because the structure of the clip is simpler than the case where the groove type hook part is formed integrally with the inner support part 114.

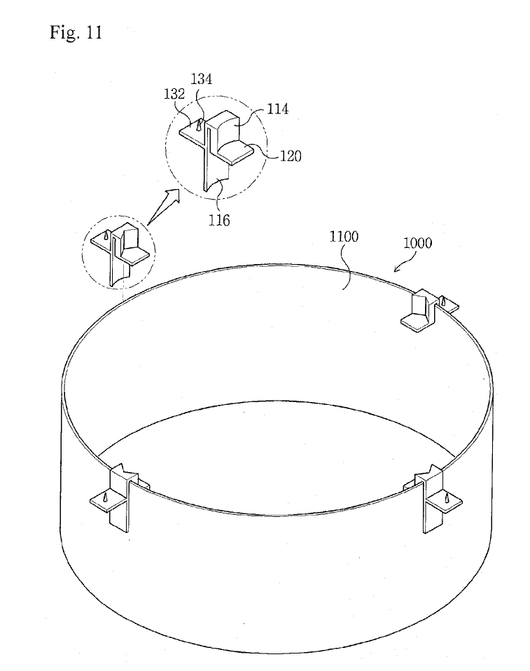

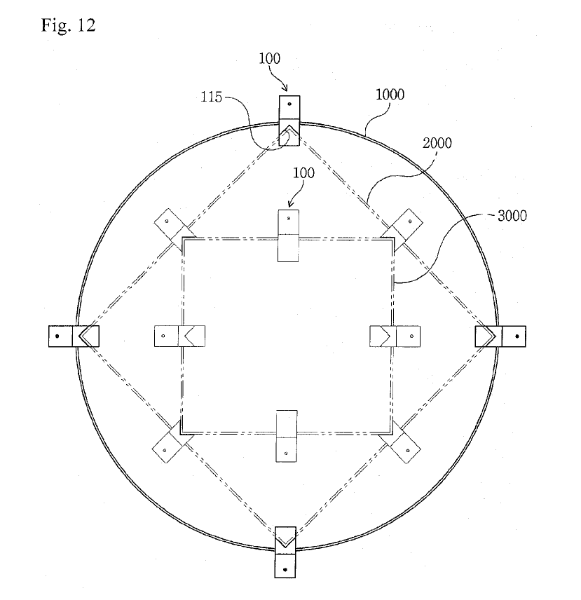

Of course, the shape of the hook part 115 may be variously modified according to the shape and material of other vessel body stacked on the vessel body 1000. In addition, the hook part 115 may be formed at the inner support part 114 or mounting part 120, or at both of them. FIGS. 11 and 12 are views illustrating modification examples of shape of the vessel clip 100 when the side wall of vessel body 1000 is curved, such as by being formed in a circular or oval shape. The coupling groove 112 and even the inner support part 114 and the outer support part 116 may be formed to be curved to match the outer and inner surfaces of the vessel body.

Of course, when the vessel body 1000 is made of flexible material such as paper, the vessel clip 100 can be combined with the side wall 1100 through an interference fit method even if the outer support part 116 and coupling groove 112 are not formed in the curve shape.

In addition, when the other vessel body stacked on the mounting part 120 is circular, an additional hook part is unnecessary. Accordingly, the hook part may not be formed as shown in the magnified drawing, or the front surface of the inner support part 114 may be curved to correspond to the outer circumference of the other vessel body.

Of course, as shown in FIG. 12, when the second vessel body 2000 is polygonal under the condition that the first vessel body 1000 is circular, the hook part 115 may be formed in a shape of V as described above.

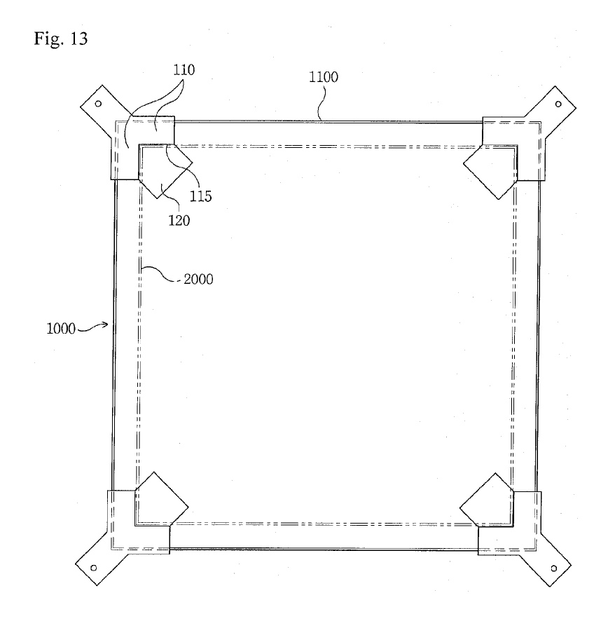

FIG. 13 shows an example that the vessel clip 100 is modified to be combined with a corner of the vessel body 1000. As shown in the drawing, the clip body 110 is formed to be fastened to both side walls of the vessel body 1000 and simultaneously a coupling groove thereof is formed to be matched with an angle of the corner.

Of course, the structure of the clip may be more simplified by providing the attaching member 200 as described above.

A process for stacking the vessel bodies and improving display effect through the light-emitting member will be explained below.

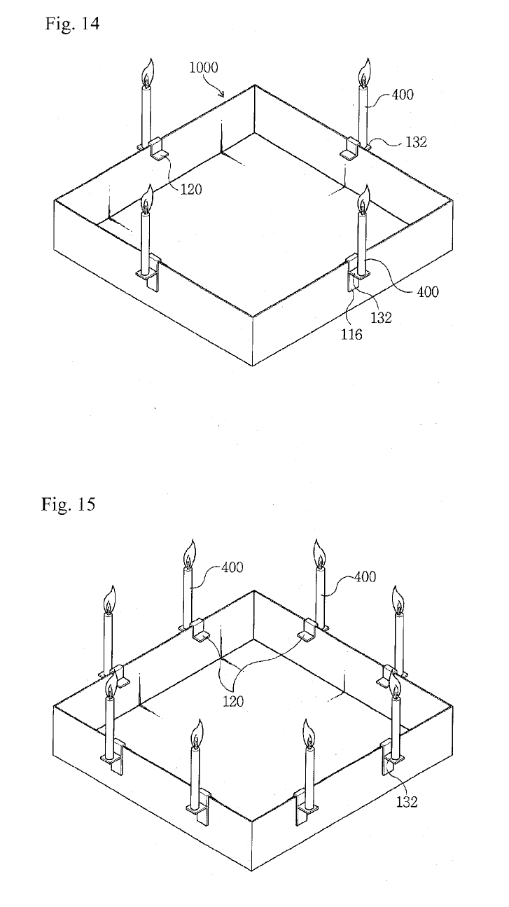

Firstly, an example for installing the light-emitting member (hereinafter, referred to as ‘candle’) on a single vessel body 1000 will be explained. As shown in FIG. 14, firstly, food suitable to a user's taste such as chicken, pizza, cookie, bread or chop suey is contained in the vessel body 1000. Then, the vessel clip 100 is combined with the vessel body 1000 by inserting an upper end of an side wall 1100 of the vessel body 1000 into a coupling groove 112 of the vessel clip 100.

Then, a candle is stuck in a fixing member 134 provided on each light-emitting member stand 132 and a light is put to the candle, thereby providing food such as a cake for a candle event.

In this time, if a container for the food is already prepared, the container itself can be used without preparing an additional vessel body.

As described above, the candle can be provided on a usual container through the vessel clip 100. Accordingly, the user can perform the candle event by using food according to the user's taste. Thus, a particular food for the candle event may not be prepared.

In addition to food, the candle event may be performed by using a gift or a souvenir contained in the vessel, thereby providing effect of unusual event. In addition, the clip may be used for various event. Thus, the clip may be used in more fields compared than the conventional method using the cake.

In addition, as shown in FIG. 15, more candles may be provided through a plurality of vessel clip 100 on each side wall 1100 in order to obtain more splendid effect when the user puts a light to them. Thus, the candle event effect can be obtained regardless of appearance of the vessel body 1000.

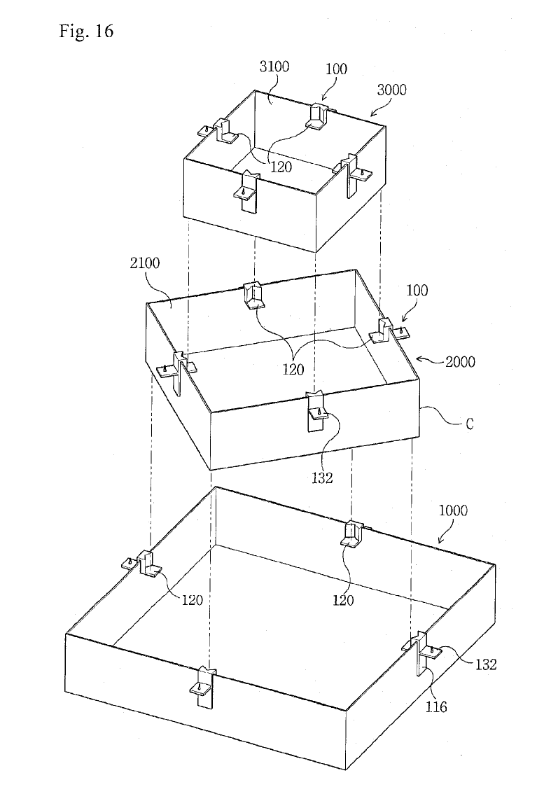

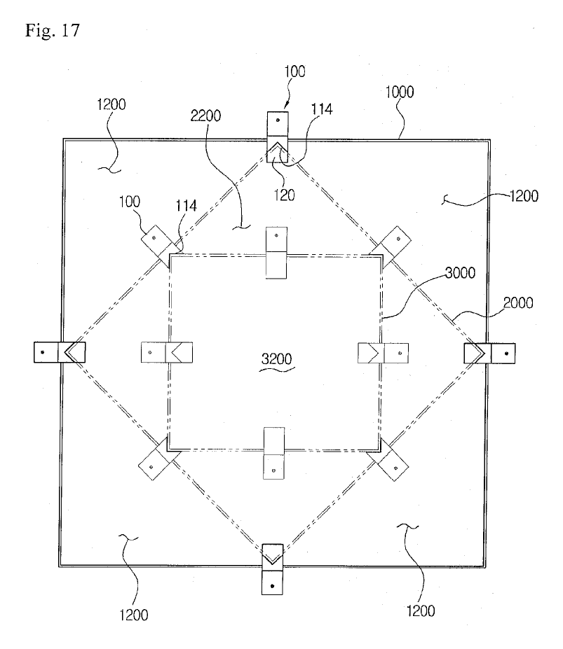

When the user wants to obtain better display effect through stacking vessel bodies, the vessel clip 100 is combined with a position of each side wall 1100 of the vessel body 1000 where each corner (C) of bottom of a second vessel body 2000 is located as shown in FIG. 16. Then, the bottom of the additionally prepared second vessel body 2000 is seated on the mounting part of the each vessel clip 100. In this time, as shown in the drawing, when the first and second vessel bodies 1000 and 2000 are rectangular boxes, an area of the second vessel body 2000 is smaller than the first vessel body 1000. In addition, the second vessel body 2000 is rotated by 45° on a plane as shown in FIG. 17, thereby allowing each corner of the second vessel body 2000 to be inserted into a groove type hook part 115 formed in each vessel clip 100.

Accordingly, the second vessel body 2000 seated on the mounting part 120 is prevented from being moved unnecessarily and thus prevented from being dropped.

In addition, when the second vessel body 2000 is rotated by 45° and seated on the rectangular vessel body as described above, a receiving space 1200 of the first vessel body 1000 is maximally exposed as shown in the drawing. Thus, food contained in the vessels is exposed and looks plentiful.

Next, the vessel clip 100 is provided on each side wall 2100 of the second vessel body 2000. Then, an additional third vessel body 3000 is seated on the mounting part 120 of the vessel clip 100 combined with the second vessel body 2000 and simultaneously each corner is hooked on the hook part 115.

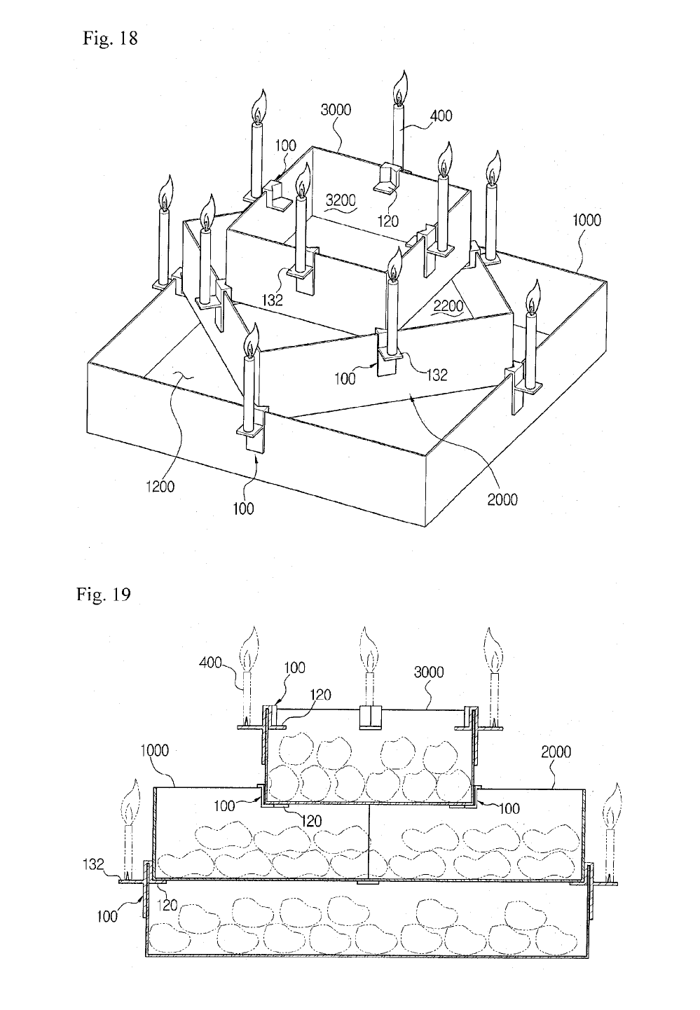

Also in this time, when the third vessel body 3000 is rotated by 45° about the second vessel body 2000, a receiving space of the second vessel body 2000 is maximally exposed similarly to the vessel body 1000. Accordingly, as shown in FIG. 18, contents contained in the stacked vessel bodies 1000, 2000 and 3000 are exposed enough. Thus, the foods contained the vessels look like main foods.

In addition, as shown in the drawing, the vessel bodies 1000, 2000 and 3000 are stacked in a multi-stage type whose width becomes narrower toward an upper part thereof, thereby providing effect of a multi-stage type cake.

Under the above state, when candles are provided on the light-emitting member stand 132 on the vessel clip 100 of the vessel bodies 1000, 2000 and 3000 and lights are put to the candles as shown in FIGS. 18 and 19, the entire vessels may be used as a main article for the candle event.

Accordingly, decoration effect is improved by providing the candles on the vessel bodies 1000, 2000 and 3000. In addition, a splendid appearance effect can be obtained by stacking the plurality of vessel bodies on each other through the mounting part 120 of each vessel clip 100.

In this time, the vessel clip 100 may be additionally provided at other positions in addition to the second and third vessel bodies 2000 and 3000 and so a larger number of candles may be provided, thereby improving decoration effect.

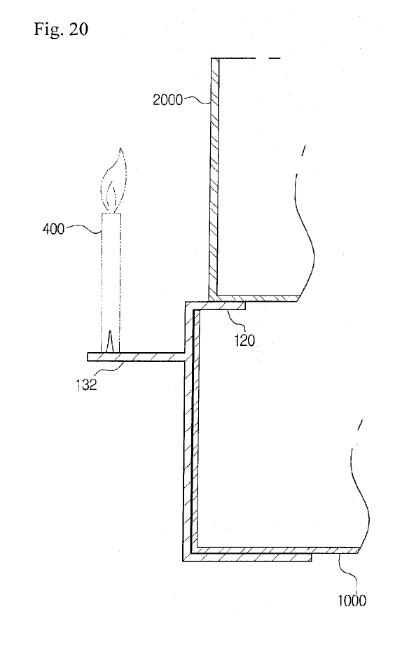

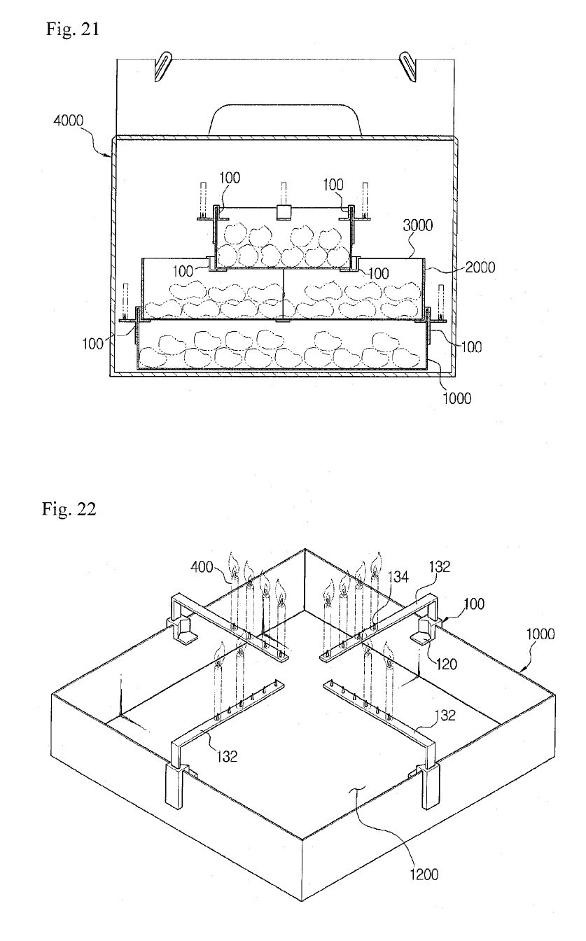

In addition, the second and third vessel bodies 2000 and 3000 may be stacked with each other as described below. An upper vessel body is laid on a lower vessel body by forming the mounting part 120 at the upper end of the vessel clip 100 as shown in FIG. 20. Or, the upper vessel body is inserted into the lower vessel body by forming the mounting part 120 at a lower position as shown in FIG. 3. In addition, the stacked vessel bodies 1000, 2000 and 3000 may be received in an additional container 4000 for transport. In this time, the container 4000 serves as a cake wrapping box.

The coupling structure between the clip and vessel body, the shape of the hook part, the position of the mounting part 120 and the light-emitting member installing part 130 may be modified differently.

One modification example will be explained below, where a light-emitting member installing part 130 is located over a receiving space of a vessel body differently from the above embodiment.

First, a light-emitting member stand 132 is formed in a bar type as shown in FIG. 22. One end of the light-emitting member stand 132 emerges out of the upper part of a clip body 110 and the other end is located in the middle of the vessel body.

In this time, one or more fixing members 134 are arranged in a length direction of the light-emitting member stand 132 and thus candles are located over a receiving space of the vessel body 1000, thereby providing effect of directly sticking candles into food or other content held in the vessel.

In addition, when candles are stuck in light-emitting member stand 132 extended from four side walls, the candles are located in four directions over the content in the receiving space 1200 differently from the above embodiment where the candles are provided outside the vessel body. Thus, unusual decoration effect is obtained compared to the conventional method in which the candles are directly stuck in the content.

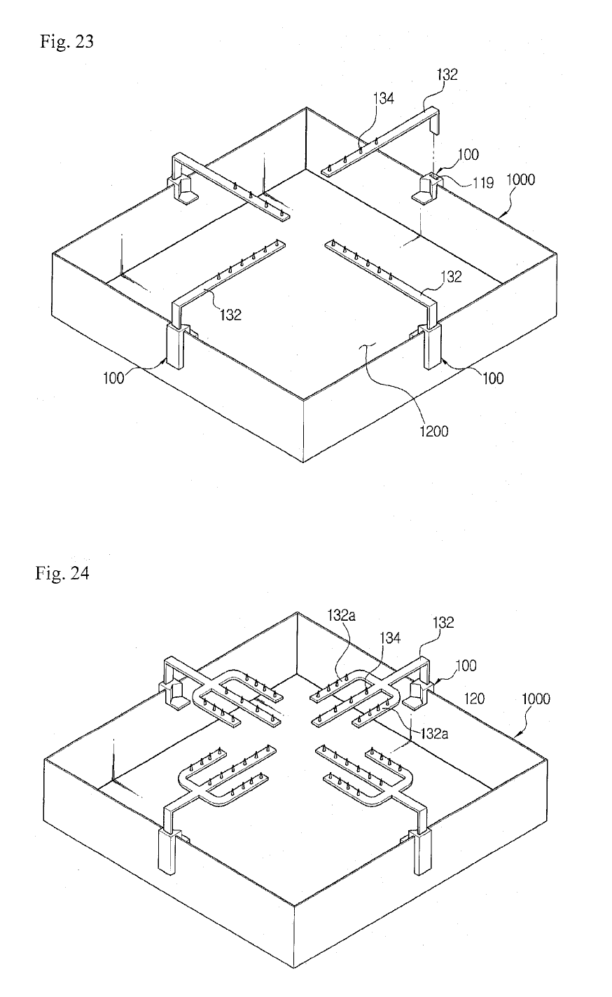

In this time, when the light-emitting member stand 132 is formed to be detachable from the clip body 110 as shown in FIG. 23, the vessel bodies may be stacked in a multi-layered structure through removing the light-emitting member stand 132. In addition, when the bar type light-emitting member stand 132 is attached to the vessel clip 100 projected from the outer support part 116 as described in the above embodiment, the candles may be arranged in more various types.

Of course, the clip may not be provided with the mounting part 120 and include only the light-emitting member stand 132. Thus, the clip may be used only for installing the light-emitting member.

In addition, an auxiliary stand 132a may be branched from one light-emitting member stand 132 as shown in FIG. 24. In the structure, more candles can be provided to obtain a more splendid effect. In addition, a height difference may be formed between the light-emitting member stand 132 and auxiliary stand 132a, thereby providing three-dimensional effect when the user puts lights to the candles.

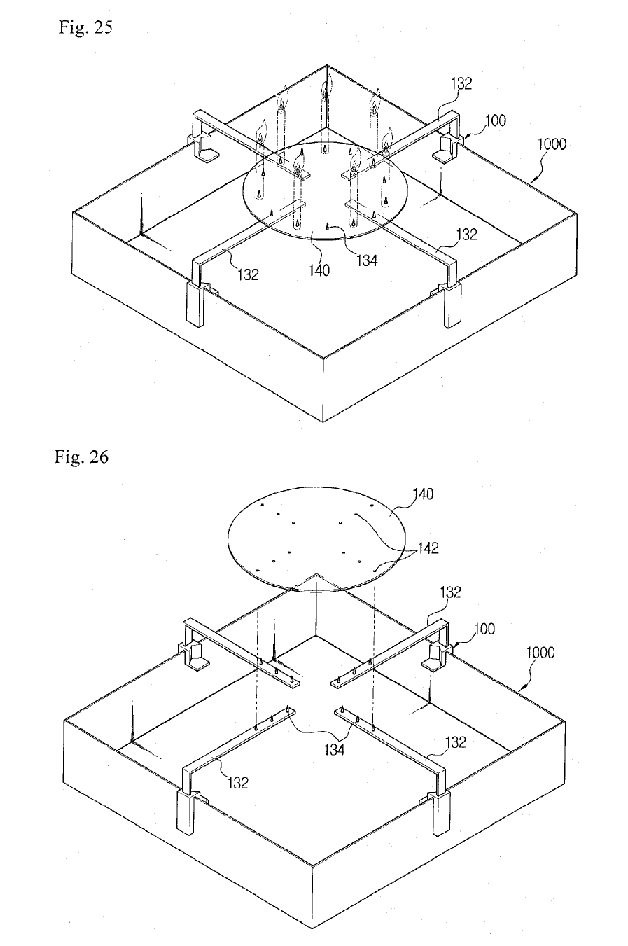

Referring to FIG. 25, each light-emitting member stand 132 extends over the receiving space 1200 from a vessel clip 100 fastened to the four side walls. An additional melted candle blocking plate 140 is placed on the light-emitting member stand 132 in order to block drops of melted candle and then candles are arranged on the light-emitting member stand 132. In this time, the candle may be fixed by the fixing member 134 formed on the melted candle blocking plate 140. Or, as shown in FIG. 26, the candle may be fixed by the fixing member 134 formed on the light-emitting member stand 132, where the fixing member 134 is exposed through an opening 142 formed in the melted candle blocking plate 140 when the melted candle blocking plate 140 is seated on the light-emitting member stand 132.

In this time, the melted candle blocking plate 140 is more stably installed compared to the case where the melted candle blocking plate 140 is merely laid on the light-emitting member stand 132, thereby preventing the melted candle blocking plate 140 from being dropped by external impact.

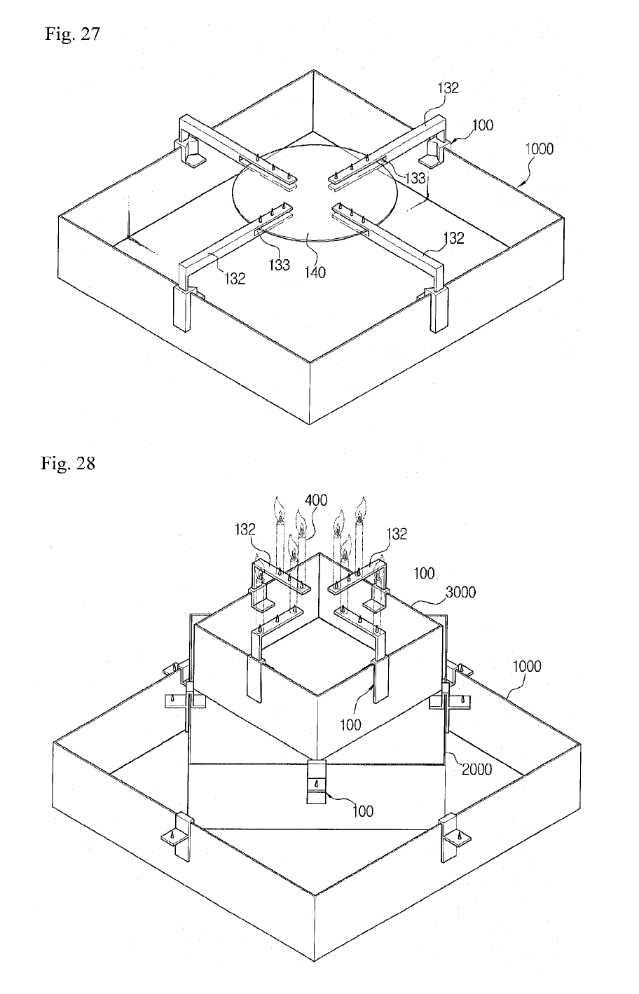

In addition, as shown in FIG. 27, a second end portion of the light-emitting member stand 132 may terminate in a slot 133 configured to receive the melted candle blocking plate 140, which may be inserted into the slot 133. Also in this time, the fixing member 134 may be formed on the melted candle blocking plate 140 in addition to the light-emitting member stand 132 in order to stick more candles.

It is desirable that the melted candle blocking plate 140 is made of transparent material in order to make the content visible through the melted candle blocking plate 140.

Referring to FIG. 28, a bar type light-emitting member stand 132 is applied to vessel bodies stacked in a multi-layered structure.

As shown in the drawing, a vessel clip 100 used in first and second vessel bodies 1000 and 2000 includes the light-emitting member stand 132 provided on an outer support part 116. The bar type light-emitting member stand 132 may be used only on a third vessel body 3000 located at the uppermost position.

Accordingly, candles are arranged outside the first and second vessel bodies 1000 and 2000 and the candles are over the content at the third vessel body 3000 that is relatively more exposed. Accordingly, the content in the third vessel body 3000 looks prominently and thus decoration effect is improved.

However, an area of the third vessel body 3000 is relatively small compared than other vessel bodies. Accordingly, the light-emitting member stand 132 should be shorter than the light-emitting member stand provided at other vessel body. Therefore, there is caused a problem that too many kinds of light-emitting member stands should be made when the light-emitting member stand is made to have a length corresponding to the area of each vessel body.

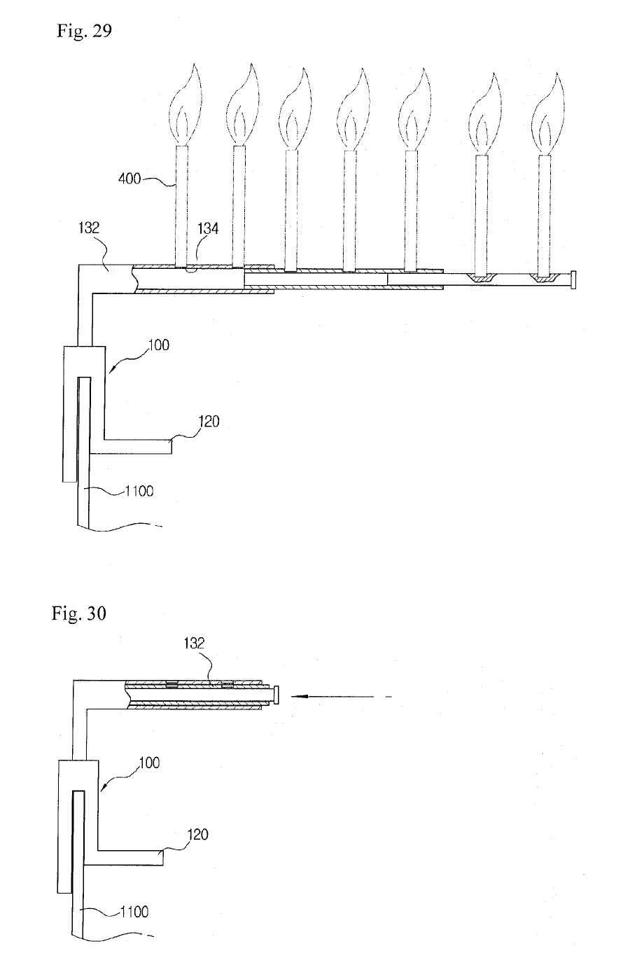

Accordingly, the light-emitting member stand 132 may be made to telescope and be extended/retracted in multi-stages. In other words, the light-emitting member stand 132 may be made in a retractable antenna type as shown in FIG. 29. When the light-emitting member stand 132 is used in a large vessel body, the light-emitting member stand 132 is extended. Or, when the light-emitting member stand 132 is used in a small vessel body as shown in FIG. 30, the light-emitting member stand 132 is retracted.

Accordingly, the light-emitting member stand 132 of one size can be applied in various areas of vessel bodies because the length thereof is adjustable. Thus, the manufacturing process is simplified.

In this time, the fixing member 134 is formed in a groove type so as not to interfere extension/retraction of the light-emitting member stand 132.

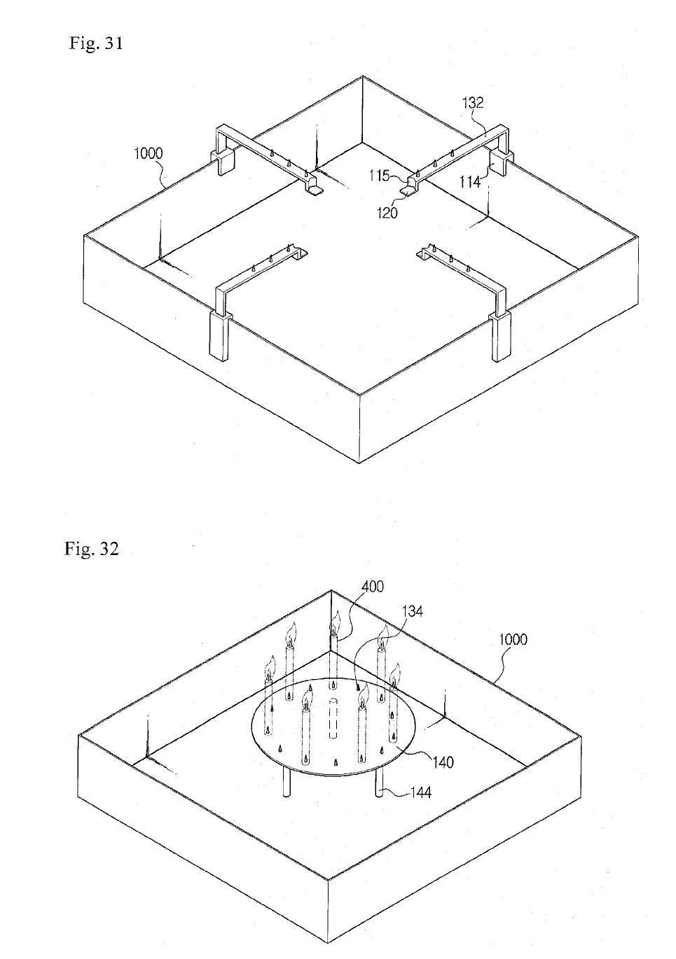

FIG. 31 shows a still another embodiment in which a hook part 115 and a mounting part 120 are formed at a tip of a light-emitting member stand 132 that is located over a container. In the embodiment, positions of the mounting part 120 and light-emitting member stand 132 do not overlap each other. Accordingly, even if the light-emitting member stand 132 is a bar type, the vessel bodies can be stacked in a multi-layered structure. In addition, candles can be arranged around the vessel body laid on the mounting part 120, there by improving decoration effect. In addition, the mounting part 120 is more displaced toward the middle of the receiving space through the light-emitting member stand 132. Thus, the multi-layered structure can be easily formed even if the areas of the upper and lower vessel bodies are largely different from each other.

When the multi-stage retractable light-emitting member stand in FIG. 29 is applied to the above structure, the light-emitting member stand can be used regardless of the difference between areas of the vessel bodies.

Finally, as shown in FIG. 32, a melted candle blocking plate 140 itself may be laid over the content by using a predetermined length of stand formed under the melted candle blocking plate 140.

When the content is pizza for example, each stand of the melted candle blocking plate 140 may serve as a clip that is usually used to prevent separation of the pizza.

Each feature of the each embodiment may be combined with each other.

Various feature of the vessel clip of the present invention as described above may be variously modified by those of ordinary skill in the art. However, the various replacements, modifications and changes in the form and details may be made therein without departing from the spirit and scope of the present invention as long as a mounting part is provided on a vessel body whose upper part is open and a vessel body can be stacked on the mounting part, or a light-emitting member can be provided.

The vessel clip according to the present invention can provide display effect such as a cake in itself due to the shape of multi-layered stack and light-emitting member when food is contained in each vessel body. Accordingly, the food contained in the vessel body can be used as food for a main event instead of a special food such as the cake.

What is claimed is:

1. A vessel clip used for a first vessel whose upper part is open, comprising:
a clip body provided on a side wall of the first vessel; and
a mounting part extending from the clip body over a receiving space of the first vessel; wherein:
the vessel clip is configured to support a second vessel stacked on top of the first vessel by seating said second vessel on the mounting part of the vessel clip.

2. The vessel clip of claim 1, wherein:
an inner support part is located inside the first vessel about a coupling groove formed at a lower part of the clip body of the vessel clip;
an outer support part is located outside the first vessel about the coupling groove; and
the mounting part extends from the inner support part.

3. The vessel clip of claim 2, wherein:
a hook part is formed on at least one of the inner support part and the mounting part of the vessel clip, the hook part configured to prevent movement of the second vessel, when the second vessel is seated on the mounting part of the vessel clip.

4. The vessel clip of claim 3, wherein:
the hook part comprises a V-shaped groove having a vertically extending vertex, as seen in a top view of the vessel clip; and
the hook part is configured to receive a corner of the second vessel, when the second vessel is seated on the mounting part of the vessel clip.

5. The vessel clip of claim 2, further comprising:
a lower support part extending at an angle from the outer support part, the lower support part configured to support a bottom of the first vessel.

6. The vessel clip of claim 1, further comprising:
a light-emitting member installing part provided on the clip body and configured to retain a light-emitting member thereon.

7. The vessel clip of claim 6, wherein the light-emitting member installing part comprises:
a light-emitting member stand extending from the clip body; and
a fixing member provided on the light-emitting member stand to fix the light-emitting member.

8. The vessel clip of claim 7, wherein:
a first end of the light-emitting member stand is fixed on the vessel clip; and
a second end of the light-emitting member stand extends over the receiving space of the first vessel, when the vessel clip is mounted on a side wall of the first vessel.

9. The vessel clip of claim 8, wherein the light-emitting member stand is detachable from the vessel clip.

10. A vessel clip configured for use with a first vessel whose upper part is open, comprising:
a clip body mountable on a side wall of the first vessel;
a light-emitting member stand extending from the clip body and configured to support a light-emitting member; and
a fixing member provided on the light-emitting member stand to fix the light-emitting member.

11. The vessel clip of claim 10, wherein:
a first end of the light-emitting member stand is fixed on the vessel clip; and
a second end of the light-emitting member stand extends over a receiving space of the first vessel, when the vessel clip is mounted on a side wall of the first vessel.

12. The vessel clip of claim 10, wherein the light-emitting member stand is detachable from the clip body.

13. The vessel clip of claim 10, wherein a length of the light-emitting member stand is adjustable.

14. A vessel clip for mounting onto a side wall of a first vessel having an open top, the vessel clip comprising:
a clip body, a downwardly extending outer support part and a downwardly extending inner support part;
a coupling groove defined between the outer support part and the inner support part, the coupling groove configured to receive a portion of a side wall of a first vessel, when the vessel clip is mounted on a side wall of the first vessel;
a light-emitting member part extending from the clip body, the light-emitting member part comprising a light-emitting member stand and a fixing member provided on the light-emitting member stand, the fixing member configured to fix a light-emitting member; and
a mounting part extending from the clip body and configured to support a second vessel, when the vessel clip is mounted on the side wall of a first vessel and the second vessel is mounted on top of the first vessel.

15. The vessel clip of claim 14, wherein:
a hook part is formed on at least one of the inner support part and the mounting part of the vessel clip, the hook part configured to prevent movement of the second vessel, when the second vessel is seated on the mounting part of the vessel clip.

16. The vessel clip of claim 15, wherein:
the hook part comprises a V-shaped groove having a vertically extending vertex, as seen in a top view of the vessel clip; and
the hook part is configured to receive a corner of the second vessel, when the second vessel is seated on the mounting part of the vessel clip.

17. The vessel clip of claim 14, wherein:
the light-emitting member part is provided with at least one upstanding pin configured to fix a candle; and
the mounting part is provided with at least one upstanding pin configured to fix the second vessel by passing through a bottom of the second vessel, when the second vessel is seated on the mounting part of the vessel clip.

18. The vessel clip of claim 14, wherein:
the coupling groove is curved so as to receive a first vessel having a curved side wall.

19. The vessel clip of claim 14, further comprising:
a lower support part extending at an angle from a lower portion of the outer support part, the lower support part configured to support a bottom of the first vessel, when the vessel clip is mounted on a side wall of the first vessel.

20. The vessel clip of claim 14, wherein the light-emitting member installing part comprises:
a light-emitting member stand extending from the clip body; and
a fixing member provided on the light-emitting member stand to fix the light-emitting member.

21. The vessel clip of claim 20, further comprising an auxiliary stand branched from the light-emitting member, the auxiliary stand having at least one fixing member provided thereon to fix a light-emitting member.

22. The vessel clip of claim 20, wherein the light-emitting member stand is detachable from the vessel clip.

23. The vessel clip of claim 20, wherein a length of the light-emitting member stand is adjustable.

24. The vessel clip of claim 20, wherein:
a first end of the light-emitting member stand is fixed on the vessel clip; and
a second end of the light-emitting member stand extends over the receiving space of the first vessel, when the vessel clip is mounted on a side wall of the first vessel.

25. The vessel clip of claim 24, wherein:
the second end of the light-emitting member stand terminates in a slot configured to receive a melted candle blocking plate.

26. The vessel clip of claim 24, wherein:
the second end of the light-emitting member stand terminates in a hook part configured to prevent movement of the second vessel, when the second vessel is seated on the mounting part of the vessel clip.

27. The vessel clip of claim 14, wherein:
an elastic force is provided between the inner support part and the outer support part to improve fastening strength when the vessel clip is fastened to the side wall of the first vessel

28. The vessel clip of claim 14, further comprising:
an auxiliary coupling groove formed at a portion of the vessel clip connecting the inner and outer support parts, the auxiliary coupling groove being in communication with the coupling groove and being thinner than the coupling groove.
